(19) United States
(12) Patent Application Publication
(10) Pub. No.: US 2007/0200329 A1
(43) Pub. Date: Aug. 30, 2007

(54) Woven air bag with integrally woven 3-D tethers

(75) Inventor: Xiaofeng Ma, Knoxville, TN (US)

Correspondence Address: KEY SAFETY SYSTEMS, INC.;PATENT DEPARTMENT, 7000 NINETEEN MILE ROAD, STERLING HEIGHTS, MI, 48314, US

(73) Assignee: Key Safety Systems, Inc.

(21) Appl. No.: 11/362,893

(22) Filed: Feb. 27, 2006

(51) Int. Cl. B60R 21/235

(52) U.S. Cl. 280/743.1; 280/743.2; 280/729

(57) ABSTRACT

An air bag (20) is disclosed having separable fabric layers (40, 42) that are locally integrally woven together using warp threads (82) and weft threads (80). One or more integrally woven tethers (70, 70a) extend between the fabric layers at selected locations. Each tether is formed of a plurality of threads (72, 72a). The threads (72, 72a) can be either additional threads, different from the warp or weft threads, additional warp threads, additional weft threads or any combination thereof.

### BACKGROUND OF THE INVENTION

The present invention relates to air bags and in particular a woven air bag.

Reference is made to FIGS. 10 and 11, which show a prior art construction of a curtain air bag 200. Many air bags including curtain air bags are divided into various inflatable and non-inflatable regions. The non-inflatable regions limit the inflatable volume of the air bag, permitting the use a smaller capacity inflator. Historically, the non-inflatable regions were realized by simply sewing the two opposing panels of fabrics forming the air bag. These non-inflatable regions have also been produced in integrally woven air bags in which the non-inflatable regions are formed by inter-weaving the weft or fill threads of the opposing panels. The largest of the non-inflatable regions is typically located at or behind the B-pillar of the vehicle. At this location, the occupant will not often interact with this non-inflatable region. The other non-inflatable regions are formed by sewing or interweaving the opposing panels together so there is no effective spacing between the opposing panels of the air bag. These other non-inflatable regions also control the shape and volume of the inflated air bag. Another type of volume control in an air bag uses a tethering concept in which the distance between opposing panels of the air bag is controlled by a strap or tether referred to herein as a 3-D tether. These tethers were physically sewn into the air bag as related in U.S. Pat. No. 6,886,858 or interweaved as shown in U.S. Pat. No. 6,296,276. One of the deficiencies in forming the 3-D tether by interweaving is that a number of weft or warp threads are caused to move from one panel to the other forming an X-shaped link. This construction causes a lessening of the threads and a diminishing of the strength of the air bag between the legs of the X-shaped link.

### SUMMARY OF THE INVENTION

A woven air bag has at least one inflatable chamber, preferably more than one chamber when used as a side curtain air bag. The air bag has a fabric layer integrally woven together using warp threads and weft threads. The fabric layer has an inner side and an outer side. The fabric layer has a first, front or top layer or panel and a second, rear or bottom layer or panel. Attached to the fabric layer are one or more tethers. The one or more tethers are made of a plurality of tether threads. The tether threads can be either additional threads, different from the warp or weft threads, additional warp threads, additional weft threads or any combination thereof. The tethers are in the inflatable chamber and attached to chamber walls by being woven into said fabric along two or more localized woven attachment locations. Around the at least one inflatable chamber are one or more chamber boundary regions where two fabric layers are woven together. The woven fabric layer has the same number of warp threads per inch and weft threads per inch throughout the fabric layer except at the localized woven tether attachment locations and the one or more chamber boundary regions.

### BRIEF DESCRIPTION OF THE DRAWINGS

FIG. 1 shows a plan view inflated head/side air bag according to the present invention.

FIG. 2 shows a cross-sectional view of a portion of the inflated air bag taken along lines 2-2 and showing an inflated chamber and the peripheral boundaries surrounding the chamber.

FIG. 3 shows an exemplary weaving loom adapted to form the air bag of FIG. 1.

FIG. 4 shows a portion of the air bag illustrating the weaving at a first boundary region and tether attachment location y and extending towards tether attachment locations x a front or top fabric panel or layer and x′ on a rear or bottom fabric panel or layer.

FIG. 5 shows the portion of the attachment location x and the tethers extending back toward the location of the boundary region and tether attachment location y and forward to the attachment location z′ on the opposite fabric panel or layer.

FIG. 6 illustrates the attachment location z wherein the tether from the lower fabric layer crosses and attaches to the upper fabric layer and then extends toward the second boundary region at tether attachment location y′.

FIG. 7 illustrates an alternative attachment of the tether wherein the tether is interlaced between the locations y to x and y to x′ along the entire fabric layer between y and x.

FIG. 8 illustrates an alternative attachment of the tether wherein one or more point attachments can be used between locations y and x along the inside of the fabric layer.

FIG. 9 illustrates an alternative embodiment air bag according to the present invention having multiple crossing tethers inside a single chamber.

FIG. 10 is a prior art curtain air bag.

FIG. 11 is a cross-sectional view of the prior art air bag of FIG. 10.

FIGS. 12A, 12B, 12C, 12D and 12E show alternative embodiments.

### DETAILED DESCRIPTION OF THE DRAWINGS

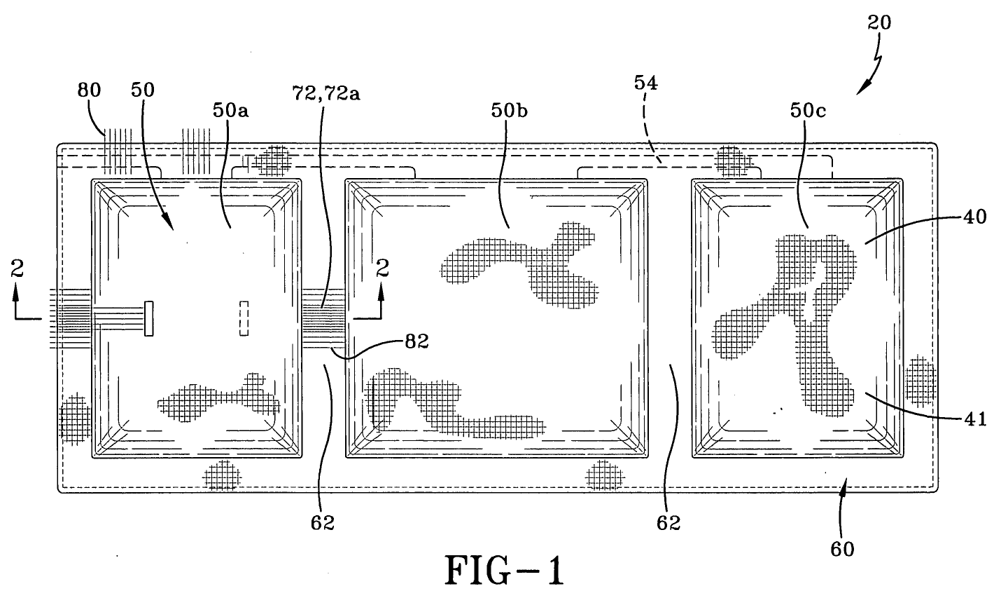

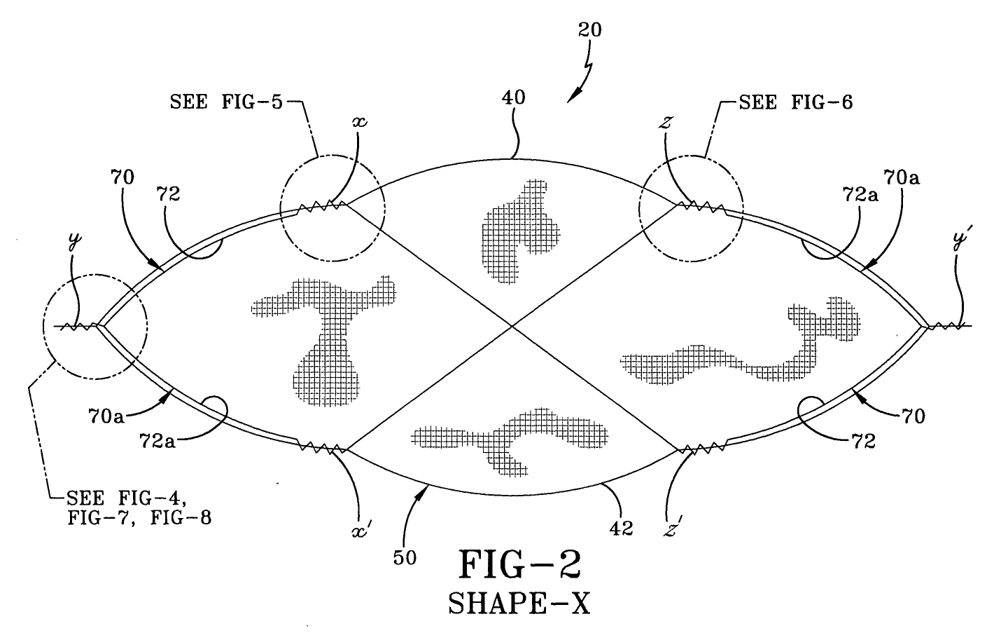

FIG. 1 shows an inflated curtain air bag 20 according to the present invention, which typically extends in the inflated state in the vehicle from the A to B pillars, A to C pillars or A to D pillars depending on the vehicle; in a typical curtain air bag extending from A to C, the air bag extends from the A pillar across the B pillar and continuing from the B pillar through to the C pillar and completely covers the side windows of the vehicle. In the inflated state, the side air bag 20 has a woven fabric which includes two fabric layers or panels 40 and 42, which can be identified better in the cross section of FIG. 2. The fabric layers or panels 40, 42 form the outer walls of the air bag. Both fabric layers or panels 40, 42 consist of warp and weft threads 82 and 80, respectively. In FIG. 1, several weft threads 80 and warp threads 82 are shown. The two fabric layers or panels 40 and 42 are interwoven into one piece in the boundary regions 60, 62 of the air bag 20. The boundary regions 60 lie around the perimeter of the air bag 20 as shown while the boundary regions 62 are partitions dividing the inflatable chambers 50.

As shown in FIG. 1 the air bag has one or more inflatable chambers 50. The illustrated air bag 20 consists of a plurality of chambers 50a to 50c, which are connected to one another through internal flow passages 54. Between the chambers 50a to 50c, the fabric layers or panels 40 and 42 are also interwoven into one piece in the boundary regions 62 that represent the partitions separating the chambers 50. The air bag 20 may be coated typically on the outside of both fabric layers or panels 40 and 42 by a film 41. The film 41 lessens the permeability of the woven fabric and in some applications ensures that the air bag 20 is gas-tight, which is especially useful in rollover air bags. For conventional side curtain air bags the film or coating 41 is not often used.

From FIG. 2 it is possible to see how the region of each chamber 50a-50c of the air bag has only a small thickness and bulges outward only slightly. In each chamber 50a, 50b, 50c there is arranged one or a plurality of straps or tethers 70 that prevent the fabric layers or panels 40 and 42 from moving away from each other. The tethers 70 are formed by non-connected or non-woven tether threads 72 that, as shown, extend in the direction of the warp threads 82 of the fabric layers or panels 40 and 42, which depart from the fabric woven borders 62 and extend over a predetermined length under each panel and finally go back into the fabric of the original (i.e. their corresponding) fabric layer or of the opposite fabric layer. The tethers 70, 70a and tether threads 72, 72a are integrated into one of the fabric layers or panels 40, 42 and transition to the other fabric layer.

In order to illustrate this, FIG. 2 shows, by way of example, several weft threads 80 and warp threads 82, which are interwoven and crisscross each other to form the first or upper fabric layer 40 in a conventional manner. The second or lower fabric layer 42 includes another set of weft and warp threads 80 and 82 respectively. Layer 40 also includes a set of tether threads 72 and layer 42 includes another set of threads 72a. Each of the tether threads 72 and 72a is integrated into the fabric layers or panels 40 and 42 and are locally interwoven with weft threads 80. In, for example, a section of boundary region 62 marked by the letter y the warp threads 82 and tether threads 72 of layer 40, and 72 of layer 42 are woven about the same weft threads 80. Similarly, also in this location y, the warp threads 82 and the tether threads 72a are woven about the same weft thread 80. In the 3-d tether chambers 50 such as 50a, b and c, the tether threads 72 can depart from the fabric 40 at the attachment location x and extend at an angle, when inflated and viewed in cross section, toward the opposite fabric layer 42 into which they then are attached at location z′ by being woven into the fabric layer 42. At location x′, the tether threads 72a depart from the fabric 42 and extend at an angle toward the opposite fabric layer 40 into which they then go toward the location z and are locally attached by interweaving. The air bag 20 chamber 50a, when viewed in cross-section, shows the tether threads 72 and 72a form an “X.” The tether threads 72 and 72a lie adjacent to one another in the flat or uninflated air bag within region defined by the “X” and are not connected to each other in this region. Since only individual tether threads 72 and 72a depart from the fabric layers or panels 40 and 42, respectively, no partition is created but tethers 70, 70a, which run generally linearly and parallel to the warp threads 82 over almost the entire length of the air bag 20 in the uninflated or flat air bag 20.

As an alternative, instead of the tether thread running parallel to the warp threads 82, they can be configured to run parallel to the weft threads 80; however, as described provides for the more efficient use of the loom.

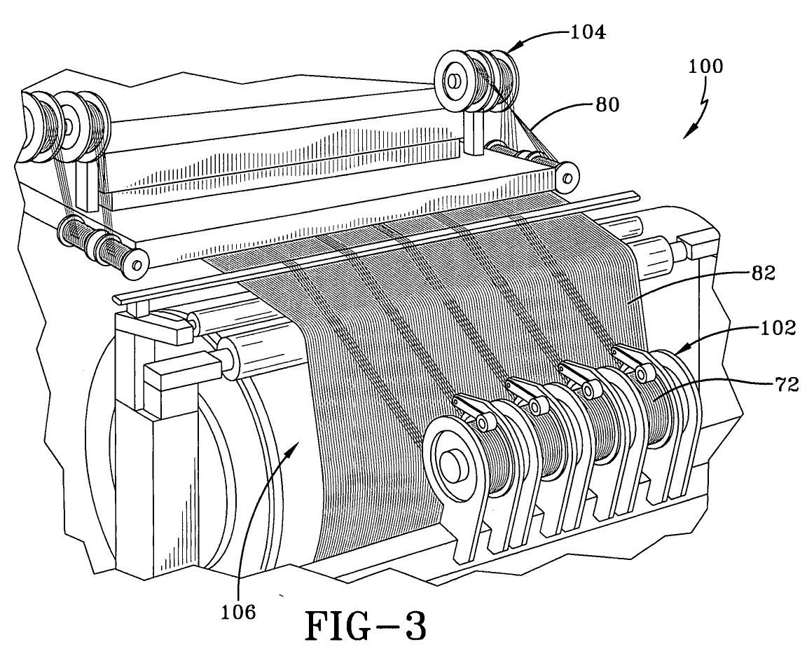

With reference to FIG. 3, the air bag 20 of the present invention can be formed using a modified Dobby Loom 100 as shown. The exemplary loom 100 has the weft threads 80 traveling in the direction shown and the warp threads 82 traveling perpendicularly relative to the weft threads. As shown, a separate beam 102 parallel to the warp threads 82 is provided to feed the tether threads 72, 72a to form the tethers 70, 70a. The choice of weaving equipment can be varied of course and optionally the tether threads 70, 70a can be the same material as the weft and warp threads, which facilitates simply locally increasing the number of threads in the locations of the tether on either from the weft package 104 or on warp beams 106. In this method of manufacture the modifications to the equipment can be minor or simply not required. In practice, if the tether threads 72, 72a are different from either the warp or weft threads, the use of a separate feed or creel arrangement on beam 102 may be more practical as is shown in the FIG. 3.

Also in the locations of the tether 70, 70a as the fabric panels 40, 42 are being assembled, especially in the case where many tether threads are needed to form a strong tether, the thread number of the beam 106 is locally increased; this causes some difficulty in keeping the beam surface flat when threads are being wound onto the beam during beaming process. Accordingly, the use of separate tether feed beams 102 seems desirable. The beams 102 can be above, below, in front of or behind the beam 106 of the parallel warp threads being loomed.

The threads 80, 82 of woven air bags are typically made of synthetic polymeric yarns such as polyamide, polyester, polyolefins (by example polyethylene and polypropylene). Other fibers such as aramid, carbon, glass and ceramic, as well as material fibers appropriately treated can be used.

The tethers 70 can have threads 72 using any of these materials mentioned above, but are not necessarily limited to yarns commonly used in woven air bag fabrics. As long as the tether threads 72, 72a can be woven into the fabric, the tether threads can be made from virtually any material. The advantage of this is various distinct properties can be utilized that enhance the strength, the elongation resistance and heat resistance of the tether yarns or threads 72, 72a without degrading the woven air bag fabric 40, 42 performance. In one embodiment of the invention the woven fabric layers 40, 42 may have warp and weft threads 82, 80 having a percent elongation (E) which is less than the percent elongation (E) of the tether threads 72, 72a. In such a configuration the tether threads 72, 72a will have more resiliency than the woven weft and warp threads. This will enable the stretch in the tethers to absorb some of the energy of inflation by stretching prior to pulling on the woven fabric at attachment locations x, x′, y, y′, z or z′. These and other arrangements of tether thread are made possible by not limiting the tether threads to be the same as the woven weft threads 80 or warp threads 82.

In one example a woven air bag 20, made in accordance with the present invention, was made with a fabric layer 40, 42 integrally woven together using warp threads 82 of 420D no-twist nylon 66 yarn and weft threads 80 of 420D no-twist nylon 66 yarn; each of the warp and weft threads used 46 ends per inch. Each fabric layer 40, 42 had an inner side 43 and an outside 45.

Tethers 70, 70a were used in the construction of the air bag 20. One or more tethers 70, 70a were made of a plurality of threads 72, 72a. The air bag 20 was tested using tether threads 72, 72a of 630D and 840D twisted nylon 66 in the warp direction. In each case the tethers had 11 ends per inch and in total used 96 ends or threads 72, 72a; the 630D threads having a strength of 1200 lb while the 840D threads had a strength of 1560 lb. These tether threads 72, 72a were different from the warp threads 82 of 420D and different from the weft threads 80 of 420D. These tether threads 72, 72a were woven into the air bag fabric layer 40, 42 at two or more localized attachment locations x, x′, y, y′, z or z′ and ran internally of the formed chamber 50 or chambers 50a, 50b and 50c.

Alternatively, as mentioned above, the one or more tethers 70, 70a could be made of a plurality of threads 72, 72a that were either additional warp threads 82, additional weft threads 80 or any combination thereof, which are preferably internal of the chamber 50 or chambers 50a, 50b and 50c and attached thereto along two or more attachment locations x, x′ and z, z′.

In the air bag 20 made according to the present invention, the woven fabric can be made with the same number of warp threads 82 having a given number of threads per inch and the same number of weft threads 80 having a given number of threads per inch, typically 50 to 100 threads per inch throughout the fabric layers 40, 42 except at the localized woven tether attachment locations x, x′ or z, z′ and at the boundary regions 60, 62. The boundary regions 60, 62, being made of the two fabric layers interwoven, similarly have double the number of threads per inch in both the weft and warp directions except at localized locations y, y′ wherein the tether threads 72, 72a are positioned. In those locations the tether thread count per inch increased locally the warp or weft thread count. It is understood the fabric layers 40, 42 can have virtually any thread count sufficient to meet the air bag performance demands and the use of 50 or less threads per inch can be employed when used with appropriate coating films 41.

With reference to FIG. 2, again several various attachment locations are shown, x, x′, y, y′, z and z′. Each of these locations, along with alternative ways in which the air bag 20 and tethers 70, 70a can be woven together, is discussed below.

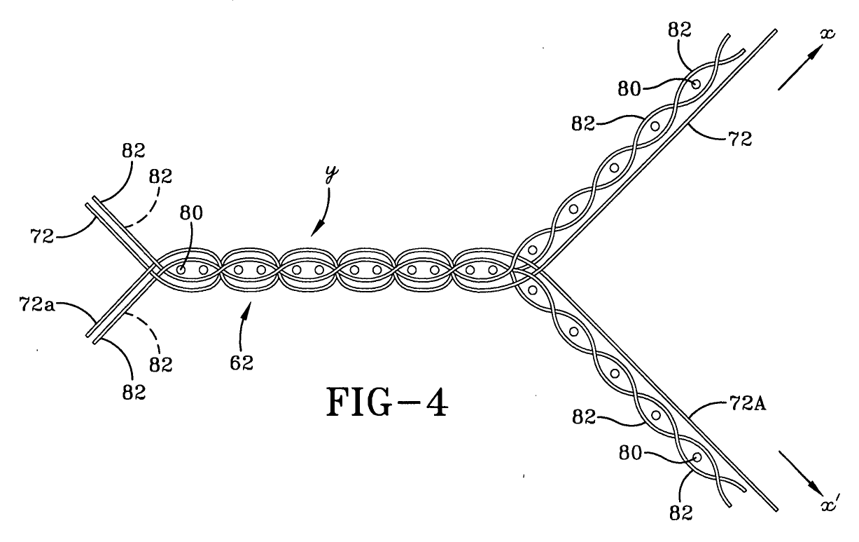

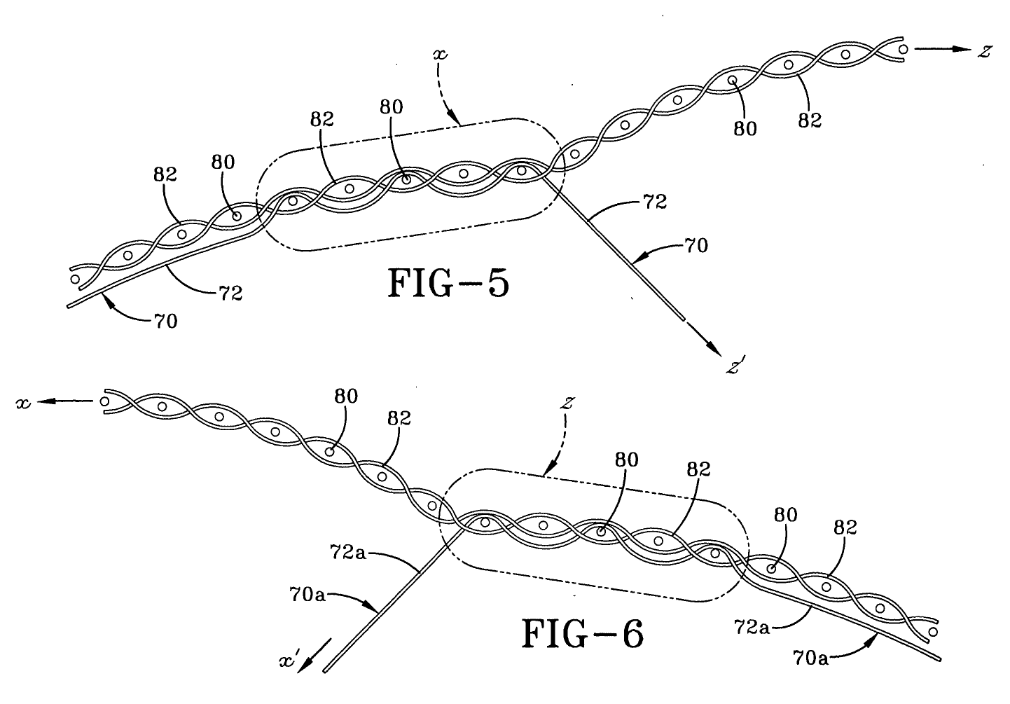

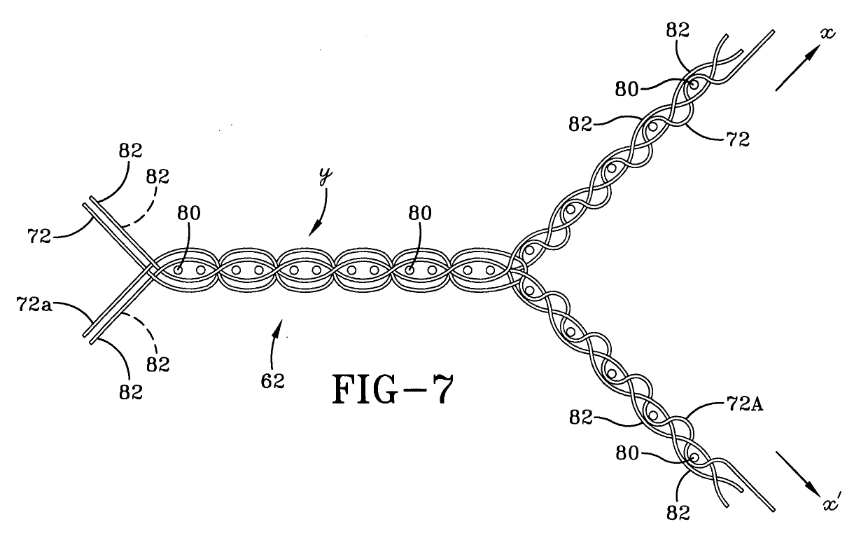

With reference to FIG. 4, at the location marked y the two fabric layers are woven together making a boundary partition region 62 between two adjacent chambers 50. In this boundary region 62 there is a doubling of the weft and warp threads 80, 82. At one or more locations y, y′ approximating the width of a tether 70, 70a additional tether threads 72, 72a pass, crossing the boundary partition region 62. As shown, threads 72a from a first tether 70 are interlaced into the partition region 62 and then pass along the inside of the top fabric panel 40 toward an attachment location x. Threads 72 from a second tether 70a are also interlaced into this partition region 62 and pass across it at the same location or at a different location and then pass along the inside of the lower fabric panel 42 to an attachment location x. In these locations the tether threads 72, 72a need not be woven into the fabric layers 40, 42, but simply pass alongside until they are attached as shown in FIG. 5 by being woven into the fabric 40, 42 across one or more weft or warp cords 80, 82, depending on the orientation of the tethers 70, 70a. As shown the tethers 70, 70a are running parallel with the warp cords 82 and thus are interlaced with the weft cords 80 at the locations x and x′.

As further shown in FIG. 2 and FIG. 5, at the attachment locations x the first tether 70 departs from the top fabric layer 40 and the second tether 70a similarly departs from the lower fabric layer 42 at location x′, each tether 70, 70a extending to the opposite fabric layer to a second attachment location z or z′ respectively. At z or z′ the threads 72, 72a of the tether 70, 70a are again interlaced with the weft cords 82 to secure the tether 70, 70a. Between the attachment locations x, z′ and x′, z the tether threads 72, 72a span across to two fabric layers 40, 42 and thus can limit the amount the two fabric layers 40, 42 can spread apart upon inflation. As shown in FIG. 2 the first tether threads 72 and the second tether threads 72a cross to form an “X” pattern inside the air bag. The tether threads 72 or 72a, once locally attached at locations z and z′, can freely extend inside the chamber formed by the two opposing fabric layers 40, 42 until it gets to the next boundary partition region 62 at y′ as shown.

In FIG. 7 an alternative method of weaving the tethers 70, 70a is shown wherein the threads 72, 72a of the tether can be interlaced not only at the attachment locations y and x and y and x′, but also all the way in between through y to x or through y to x′. Accordingly, the tether 70, 70a would be interwoven as opposed to simply lying free inside the adjacent fabric layer 40 or 42. This arrangement can occur as well crossing each boundary region 62 including z to y′ and z′ to y′ as well.

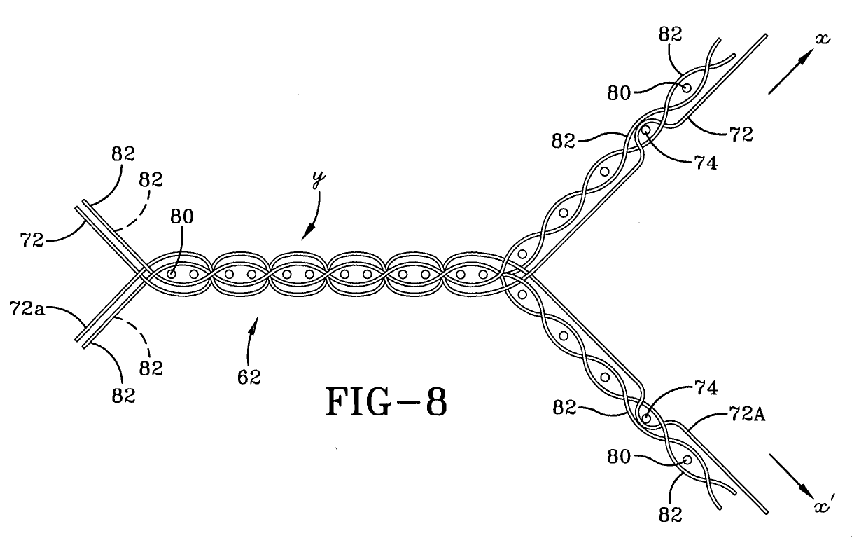

As shown in FIG. 8, another alternative is to have the threads 72, 72a of the tether 70 or 70a attached to the fabric layer 40 or 42 between attachment locations y and x or y and x′ at one or more points 74 and, as before, this use of point attachments 74 can be used between each attachment location and a boundary region 62 in z to y′ and z′ to y′.

In each of these alternatives the fabric layer 40, 42 is never reduced in thread count, but may have additional thread counts as a result of the addition of the tether threads at or optionally between the various attachment locations x, x′, y, y′, z, z′.

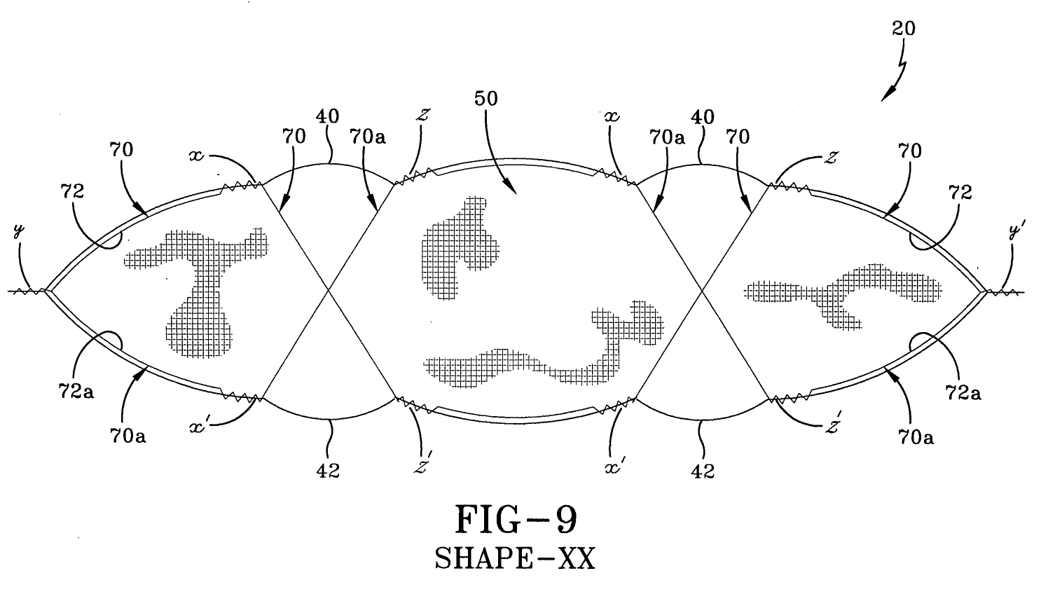

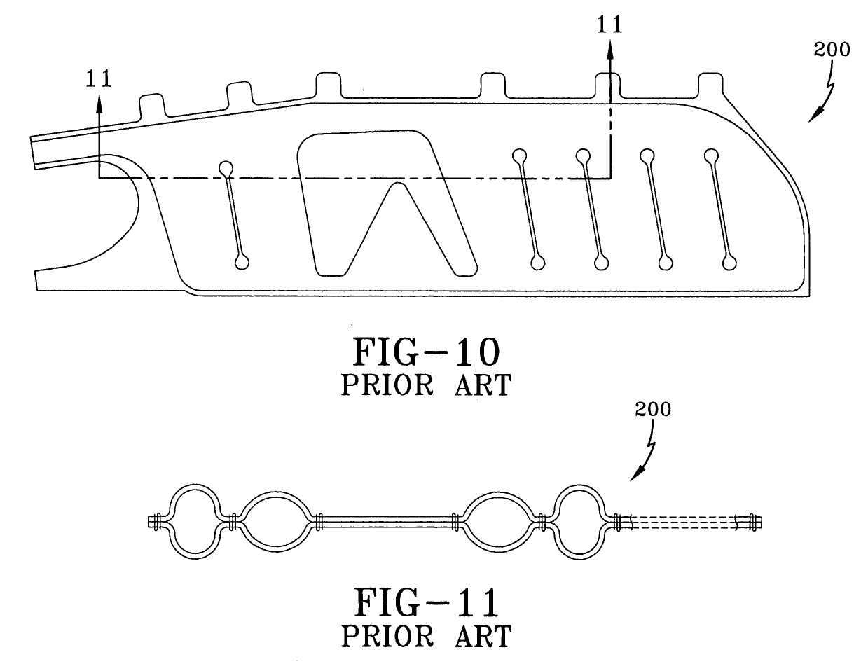

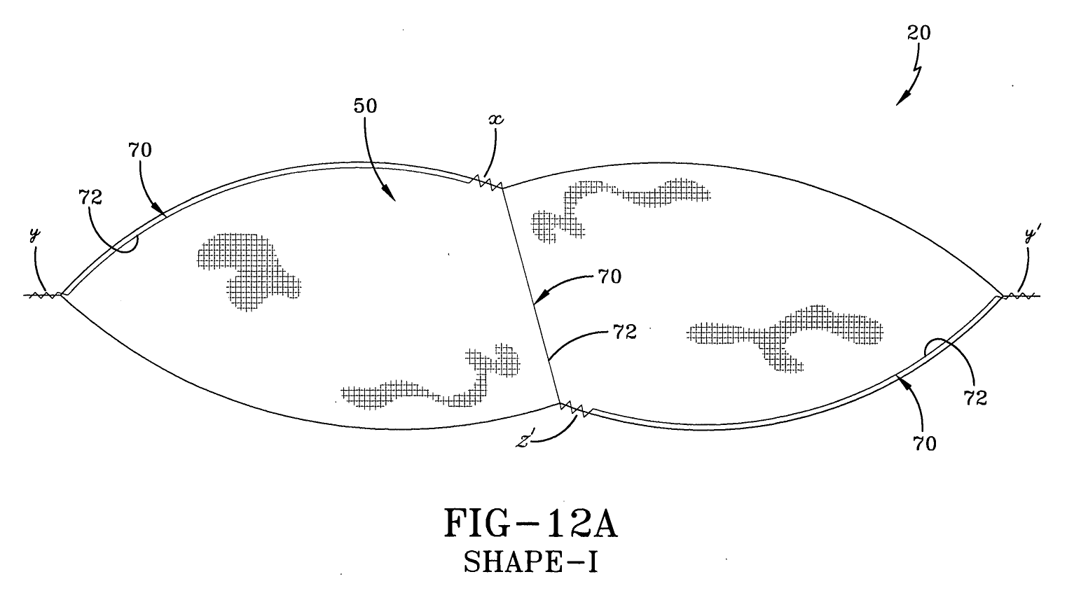

In FIG. 9 another alternative embodiment is illustrated wherein the first tether 70 and a second tether 70a cross at two locations 75, 76 inside a single chamber. As shown, the tethers 70 and 70a form two crossovers in the shape of two “X's.”

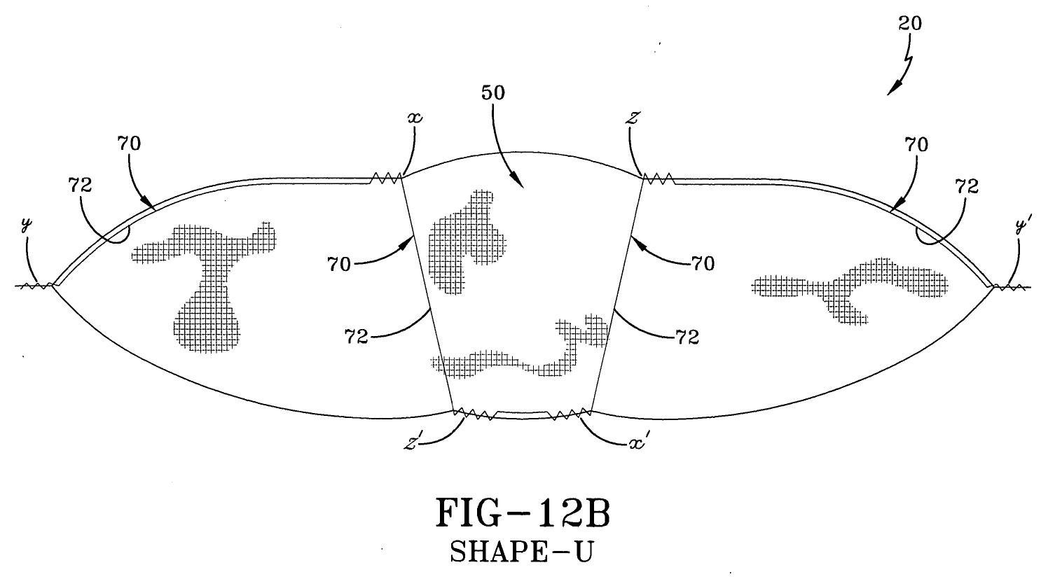

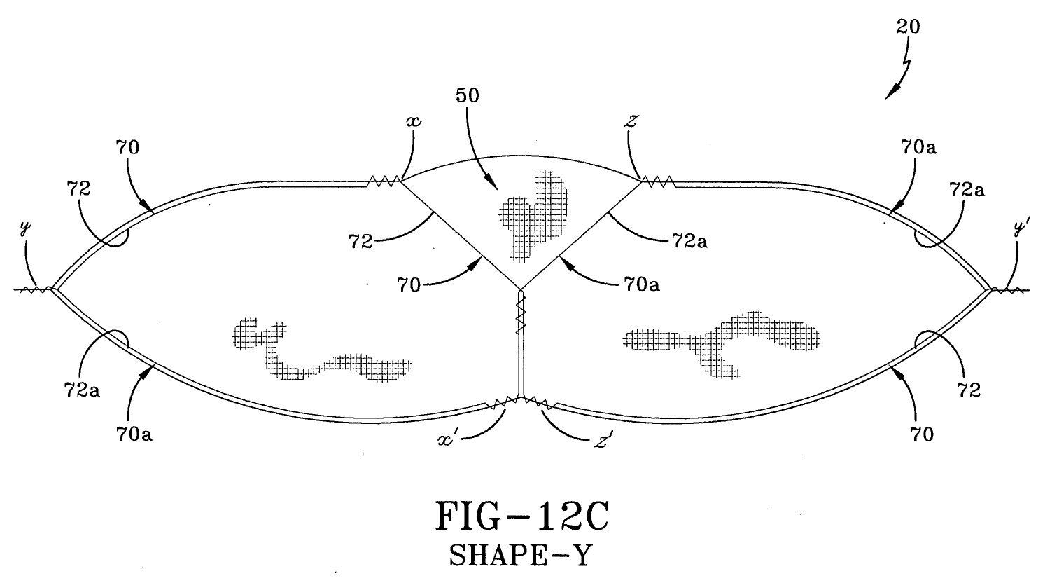

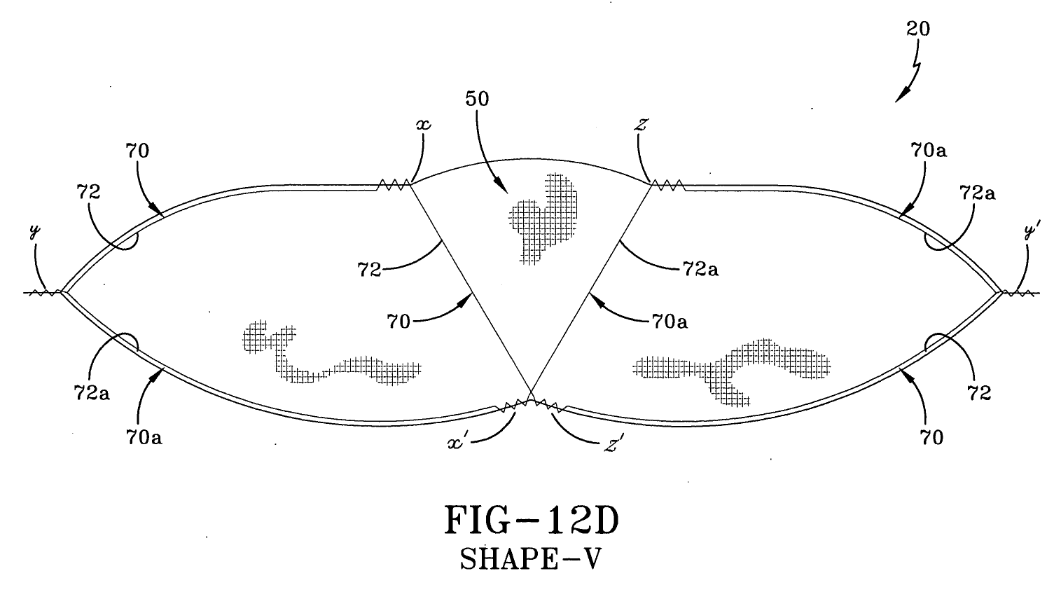

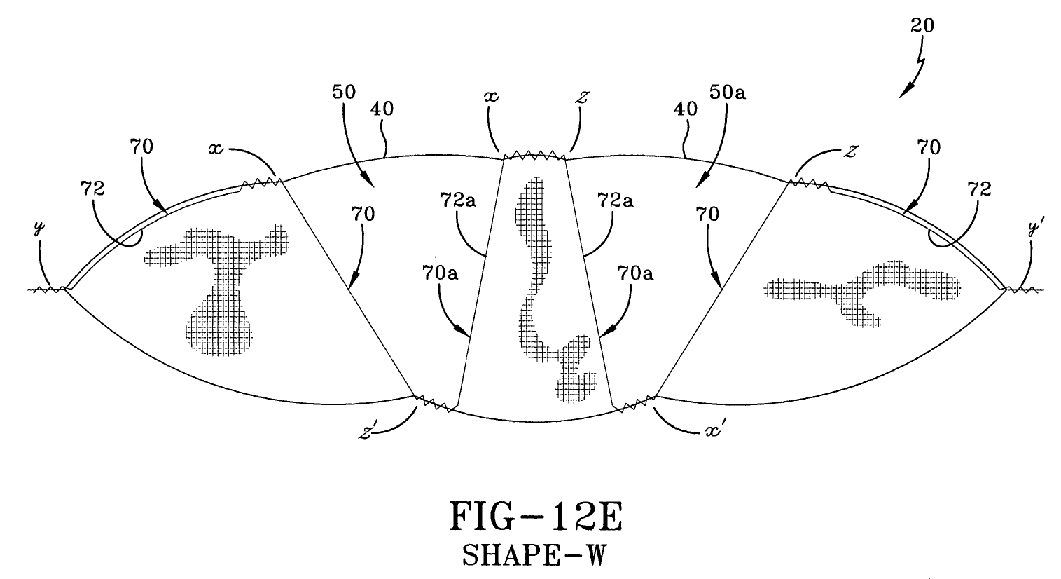

In other alternative configurations shown in FIGS. 12A, 12B, 12C, 12D and 12E, the tethers 70 or 70 and 70a can extend across the fabric layers 40, 42 in the shape of an “I”, a “U”, a “V”, a “Y” or a “W” to provide the restraint needed to keep the fabric layers from separating too far. In the locations wherein the tethers depart the fabric layer 40 or 42, it is further possible to weave the tether threads 72, 72a together at a simple point location or across the entire transition between layers. This interweaving can further enhance the tether strength if that is deemed desirable.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

1. A woven air bag having at least one inflatable chamber, the air bag comprising:
a fabric layer integrally woven together using warp threads and weft threads, the fabric layer having an inner side and an outer side;
one or more chamber boundary regions where two fabric layers are woven together;
one or more tethers, the one or more tethers being made of a plurality of threads, the threads being either additional threads different from the warp or weft threads, additional warp threads, additional weft threads or any combination thereof which are in the inflatable chamber and attached to said chamber by being woven into said fabric along two or more localized woven attachment locations; and
wherein the woven fabric layer has the same number of warp threads per inch and weft threads per inch throughout the fabric layer except at the localized woven tether attachment locations and the chamber boundary regions.

2. The woven air bag of claim 1 wherein a first tether extends across said inflatable chamber from a first attachment location on a first layer of the fabric layer to a second attachment location on a second layer.

3. The woven air bag of claim 1 wherein a second tether extends across the inflatable chamber from a first attachment location on the second layer to a second attachment location on the first layer.

4. The woven air bag of claim 1 wherein the first or first and second tethers form an “I”, “U”, “V”, “X”, “Y” or “W” across the inflatable chamber.

5. The woven air bag of claim 1 wherein one or more tethers are interwoven at a boundary region of the fabric layer and departs from the fabric layer adjacent the inner side of the fabric layer to an attachment location.

6. The woven air bag of claim 1 wherein one or more tethers are interwoven with the fabric layer between and including a boundary region to an attachment location.

7. The woven air bag of claim 1 wherein one or more tethers are interwoven at a boundary region and interwoven with one or more weft or warp cords between the boundary region and an attachment region.

8. The woven air bag of claim 1 wherein the tether threads extend or run substantially parallel to the warp threads in the fabric layer and are interwoven around the weft threads at attachment locations.

9. The woven air bag of claim 1 wherein the weft threads extend or run substantially parallel to the weft threads in the fabric layer and are interwoven around warp cords at the attachment locations.

10. The woven air bag of claim 1 wherein the plurality of tether threads is more resilient than either the weft threads or the warp threads of the woven fabric.

11. The woven air bag of claim 1 wherein the weft cords or the warp cords are 420D no-twist nylon 66.

12. The woven air bag of claim 1 wherein the tether threads are 630D twisted nylon 66.

13. The woven air bag of claim 1 wherein the tether threads are 840D twisted nylon 66.

14. The woven air bag of claim 1 wherein the weft and warp threads of the fabric layer are made of synthetic polymeric yarns.

15. The woven air bag of claim 1 wherein the weft and warp threads are made of aramid or carbon or glass or ceramic or natural material fibers appropriately treated, such as cotton, sisal, hemp or wool.

16. A woven air bag having at least one inflatable chamber, the air bag comprising:
a fabric integrally woven together using warp threads and weft threads, the fabric having a first layer and a second layer and a woven boundary;
tethers being made of a plurality of the tether threads, the tether threads being either additional threads different from the warp or weft threads, additional warp threads, additional weft threads or any combination thereof which are in the inflatable chamber and the tether threads woven into said fabric along at least one localized woven band and thereafter extending in a first direction across the air bag from a first or second layer to an opposite layer, each band having at least three sections, a first section woven in the first layer, a second section woven in the second layer and a third section transitioning between the first layer at a first transition location and entering the second layer at a second transition location; and
wherein each of the first or second fabric layer has the same number of threads per inch in the warp direction or threads per inch in the weft direction throughout except for where the tether threads are woven into the first or second fabric layers and at the woven boundary.

17. The woven air bag of claim 16 wherein a first tether extends across said inflatable chamber from a first attachment location on the first layer to a second attachment location on the second layer.

18. The woven air bag of claim 16 wherein a second tether extends across the inflatable chamber from a first attachment location on the second layer to a second attachment location on the first layer.

19. The woven air bag of claim 16 wherein the first and second tethers form an “I”, “U”, “V”, “X”, “Y” or “W” across the inflatable chamber.

20. The woven air bag of claim 16 wherein the plurality of tether threads is more resilient than either the weft threads or the warp threads of the woven fabric.
